(19) United States
(12) Patent Application Publication
(10) Pub. No.: US 2025/0332459 A1
(43) Pub. Date: Oct. 30, 2025

(54) FIRE-FIGHTING CANNON FOR THE MANAGEMENT OF FIRES

(71) Applicant: EMICONTROLS S.r.l., BOLZANO (IT)

(72) Inventor: Martin GSCHNITZER, BOLZANO (IT)

(21) Appl. No.: 19/192,569

(22) Filed: Apr. 29, 2025

(30) Foreign Application Priority Data
Apr. 29, 2024 (IT) 102024000009634

(51) Int. Cl. A62C 35/68; A62C 3/06; B05B 7/08; B05B 15/68

(52) U.S. Cl. CPC A62C 35/68; B05B 7/0869; B05B 15/68; A62C 3/06

(57) ABSTRACT

A fire-fighting cannon for the management of fires, in particular in a waste disposal centre, comprises a fixed base constrainable to a ceiling or to a vertical wall of a room defining a corresponding lying plane, a tubular body extending along an emission direction of at least one jet of fire-fighting fluid. In particular, the tubular body is arranged below or alongside the fixed base with respect to a normal direction to the lying plane. The fire-fighting cannon further comprises movement means configured to orient the tubular body between a plurality of operating positions, including an initial position in which the emission direction has a predefined angle of inclination with respect to the normal direction. The movement means is configured to orient the tubular body also in a position of inversion in which the emission direction is parallel to the normal direction, so as to emit the jet of fire-fighting fluid in a zone of the ground arranged underneath the fire-fighting cannon if the fixed base is constrained to the ceiling, or in a zone with horizontal output if the fixed base is constrained to the wall.

### TECHNICAL FIELD

The present invention relates to a fire-fighting cannon for the management of fires, for example in a waste disposal centre or in a chemicals/petrochemicals industry or in electricity transformation stations or another place not expressly indicated here.

In particular, the invention is included in the technical field of fire-fighting apparatuses and devices.

### PRIOR ART

Fires frequently break out in waste disposal plants, even several times a week, due to negligence or to a non-optimal management of the plants, as well as to the very nature of the waste present.

The plants are, in fact, often old and few in number with respect to the quantity of waste to be disposed of and, therefore, those present are greatly overloaded to the point of not guaranteeing disposal of waste in the correct times. Thus, in most cases, the fires spread unintentionally, due to poor management or infrastructural shortcomings.

As a result of the waste fires, the safety of the operators is reduced and, furthermore, pollutants continue to spread in the environment, in the form of toxic particles, for example dioxins.

Consequently, in order to seek to curb the aforesaid problem, the plants are usually provided with fire-fighting systems opportunely configured to extinguish the fires that break out.

Generally, the aforesaid fire-fighting systems comprise one or more fire-fighting cannons arranged on the ground or on support shelves present around the perimeter of the industrial shed in which the waste is present. In this manner, each fire-fighting cannon is able to intervene in a specific zone of the aforesaid room, in order to control and extinguish any fires.

However, such fire-fighting systems have several drawbacks.

In the first place, such arrangement of the fire-fighting cannons results in the formation of shadow cones below the fire-fighting cannons themselves or around them, in which it is not possible to intervene in the event of a fire.

Alternatively, in order to obtain a good surface coverage, the fire-fighting systems provide for the installation of numerous fire-fighting cannons that, nonetheless, have a significant cost for purchase, installation and maintenance.

Lastly, again due to their positioning, the fire-fighting cannons to extinguish the flames that have been created usually follow a pre-set zig-zag path capable of covering the entire surface of the fire. In order to ensure extinguishing of the fire, which is usually located even several metres from the fire-fighting cannon, the zig-zag path that is followed is very broad with respect to the surface affected by the fire and, furthermore, is followed very slowly to minimise errors. The known fire-fighting systems are therefore slow and require the use of a large quantity of water or other fire-fighting substances.

### SUMMARY

In this context, the technical task underpinning the present invention is to propose a fire-fighting cannon for the management of fires, in particular in a waste disposal centre (but not only for this type of application), which overcomes the drawbacks of the prior art cited above.

In particular, an object of the present invention is to provide a fire-fighting cannon without shadow cones and, therefore, capable of directing a flow of fire-fighting fluid onto any zone of the room of the waste disposal plant in which it is installed.

Another object of the present invention is to provide a fire-fighting cannon easily installable on a ceiling and/or on a wall of a room of a waste disposal plant. Therefore, specifically, the invention aims to provide a fire-fighting cannon that, independently of the installation point, is capable of covering the entire surface of the room in which it is installed without suffering from the presence of any shadow cone.

A further object of the present invention is to provide a fire-fighting cannon capable of intervening promptly and with the greatest accuracy possible during fighting of a fire.

The stated technical task and the specified objects are substantially achieved by a fire-fighting cannon for the management of fires, in particular in a waste disposal plant, which comprises the technical features disclosed in the independent claim. The dependent claims correspond to further advantageous aspects of the invention.

It should be noted that this summary introduces a selection of concepts in simplified form, which will be further elaborated on in the detailed description provided below.

The invention relates to a fire-fighting cannon for the management of fires, in particular in a waste disposal centre.

The fire-fighting cannon comprises a fixed base constrainable to a ceiling or to a vertical wall of a room in which waste is stored and a tubular body connected to the fixed base and, furthermore, extending along an emission direction of at least one jet of fire-fighting fluid. The ceiling or the wall of the room define a corresponding lying plane of the fire-fighting cannon. The tubular body is arranged below or alongside the fixed base with respect to a normal direction to the lying plane.

Alternatively, the cannon obtained according to the present invention could be positioned on the ground, therefore operating with a lying plane parallel to the floor or to the ground.

The fire-fighting cannon also comprises movement means for moving the tubular body with respect to the fixed base, which is configured to orient the tubular body itself between a plurality of operating positions, including an initial position in which the emission direction has a predefined angle of inclination with respect to the normal direction.

The movement means is further configured to orient the tubular body in a position of inversion in which the emission direction is parallel to the normal direction, so as to emit said at least one jet of fire-fighting fluid in a zone of the ground arranged underneath the fire-fighting cannon if the fixed base is constrained to the ceiling, or in a zone with horizontal output if the fixed base is constrained to the wall.

Advantageously, the movement of the tubular body in a plurality of operating positions, also including the position of inversion, allows a fire-fighting cannon without shadow cones to be obtained. In other words, the fire-fighting cannon in accordance with the invention is advantageously configured to emit a flow of fire-fighting fluid along various emission directions, in order to cover the entire surface of the floor of the room in which the waste is present.

In fact, if the fixed base is constrained to the ceiling, the tubular body in the position of inversion is configured to align the emission direction of the flow of fire-fighting fluid along the normal direction to the ceiling, i.e. to a vertical direction. In this manner, the fire-fighting cannon is able to intervene in the zone of the ground underneath, whereas the surrounding zones are reachable by means of the movement of the tubular body into any one of the other operating positions.

Otherwise, if the fixed base is constrained to the vertical wall, the tubular body in the position of inversion is configured to align the emission direction of the flow of fire-fighting fluid along the direction parallel to the ceiling, i.e. to a horizontal direction and parallel to the ground. In this manner, the fire-fighting cannon is able to intervene in the zones of the ground furthest away from the fire-fighting cannon itself, whereas the zone underneath is reachable with positioning of the tubular body (i.e., the emission direction) perpendicular with respect to the normal direction to the vertical wall.

### BRIEF DESCRIPTION OF THE DRAWINGS

Further features and advantages of the present invention will become more apparent from the indicative and thus non-limiting description of a preferred but non-exclusive embodiment of a fire-fighting cannon, as illustrated in the attached drawings, in which:

FIG. 1 illustrates, according to a side view, a preferred embodiment of the fire-fighting cannon in accordance with the invention;

FIGS. 2A and 2B illustrate, according to a side view, further operating positions in which the tubular body of the fire-fighting cannon illustrated in FIG. 1 is able to abut;

FIG. 3 illustrates, according to a rear and perspective view, a fire-fighting cannon in which several of the movement means are more clearly shown;

FIG. 4 illustrates, according to a perspective view, the movement means shown in FIG. 3;

FIG. 5 illustrates, according to a front and perspective view, a fire-fighting cannon in which several of the movement means are more clearly shown;

FIG. 6 shows, according to a perspective view, the movement means shown in FIG. 5.

With reference to the drawings, they serve solely to illustrate embodiments of the invention for the purpose of better clarifying, in combination with the description, the inventive principles at the basis of the invention.

### DETAILED DESCRIPTION OF AT LEAST ONE EMBODIMENT

The present invention is directed to a fire-fighting cannon which, with reference to the figures, has been generically indicated with the number 1.

Any modifications or variants which, in light of the description, should be evident to the person skilled in the art, must be considered as falling within the scope of protection established by the present invention, according to considerations of technical equivalence.

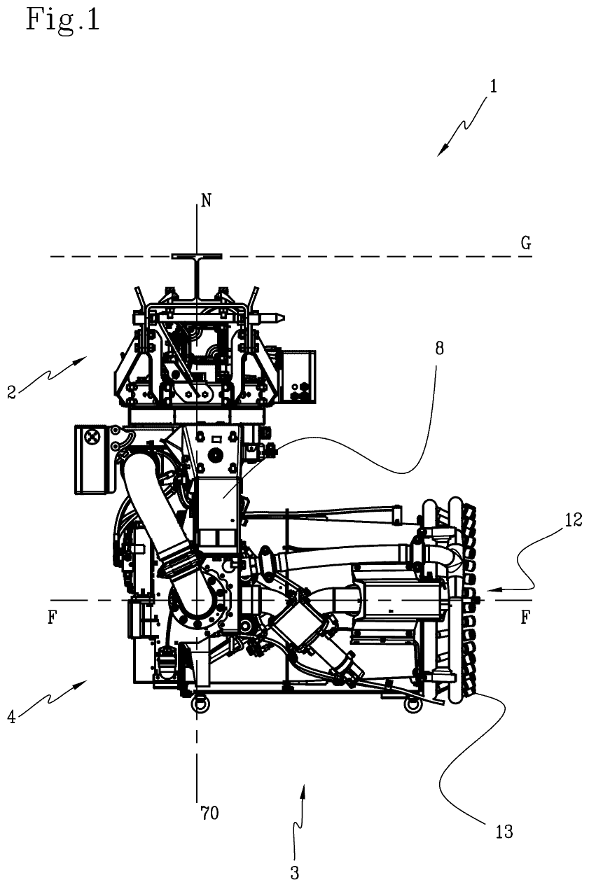

FIG. 1 shows a preferred embodiment of the fire-fighting cannon 1 for the management of fires installed on the ceiling of a room, in particular in a waste disposal centre or in a chemicals/petrochemicals industry or in electricity transformation stations or another place not expressly indicated here.

In detail, the fire-fighting cannon 1 comprises a fixed base 2 constrainable to a ceiling of a room, for example an industrial shed for the storage of waste, or any other building. The fixed base 2 consequently defines with the ceiling a lying plane G for the fire-fighting cannon 1 in which the lying plane G is parallel to the ceiling on which the cannon 1 is installed. In particular, in FIG. 1 it is visible that the fire-fighting cannon 1 is constrained to a “T-shaped” beam of the ceiling, defining the aforesaid lying plane G.

Alternatively, the cannon 1 obtained according to the present invention could be positioned on the ground, therefore operating with a lying plane G parallel to the floor or to the ground.

The fire-fighting cannon 1 also comprises a tubular body 3 that extends along an emission direction F of at least one jet of fire-fighting fluid and, furthermore, is connected to the fixed base 2. In addition, the tubular body 3 is arranged below upside down (in the case of fixing to the ceiling) or alongside the fixed base 2 (in the case of fixing to the wall) with respect to a normal direction N to the lying plane G.

The fire-fighting cannon 1 further comprises movement means for moving the tubular body 3 with respect to the fixed base 2, which is configured to orient the tubular body 3 itself between a plurality of operating positions, including an initial position in which the emission direction F has a predefined angle of inclination with respect to the normal direction N.

In accordance with the present invention, the movement means are configured to orient the tubular body 3 in a position of inversion in which the emission direction F is parallel to the normal direction N so as to emit at least one jet of fire-fighting fluid in a zone of the ground arranged underneath the fire-fighting cannon 1.

Advantageously, the movement of the tubular body 3 in a plurality of operating positions, also including the position of inversion, allows a fire-fighting cannon 1 without shadow cones to be obtained. In other words, the fire-fighting cannon 1 in accordance with the invention is advantageously configured to emit a flow of fire-fighting fluid along various emission directions F, in order to cover the entire surface of the floor of the room in which the waste is present.

In fact, if the fixed base 2 is constrained to the ceiling (FIG. 1), the tubular body 3 in the position of inversion is configured to align the emission direction F of the flow of fire-fighting fluid along the normal direction N to the ceiling, i.e. to a vertical direction. In this manner, the fire-fighting cannon 1 is able to intervene in the zone of the ground underneath, whereas the surrounding zones are reachable by means of the movement of the tubular body 3 into any one of the other operating positions.

Otherwise, if the fixed base 2 is constrained to the vertical wall, the tubular body 3 in the position of inversion is configured to align the emission direction F of the flow of fire-fighting fluid along the normal direction N to the vertical wall, i.e. to a horizontal direction and parallel to the ground. In this manner, the fire-fighting cannon 1 is able to intervene in the zones of the ground furthest away from the fire-fighting cannon 1 itself, whereas the zone underneath is reachable with positioning of the tubular body 3 (i.e., the emission direction F) perpendicular with respect to the normal direction N to the vertical wall.

In that case, the fixed base 2 is constrainable to a vertical wall of the room that, consequently, defines a corresponding lying plane G orthogonal with respect to the ground. In this case, therefore, the normal direction N is horizontal and parallel to the ground. As a consequence, in such configuration of connection to the vertical wall, the tubular body 3 is oriented so as to emit at least one jet of fire-fighting fluid in a zone of the ground with horizontal output.

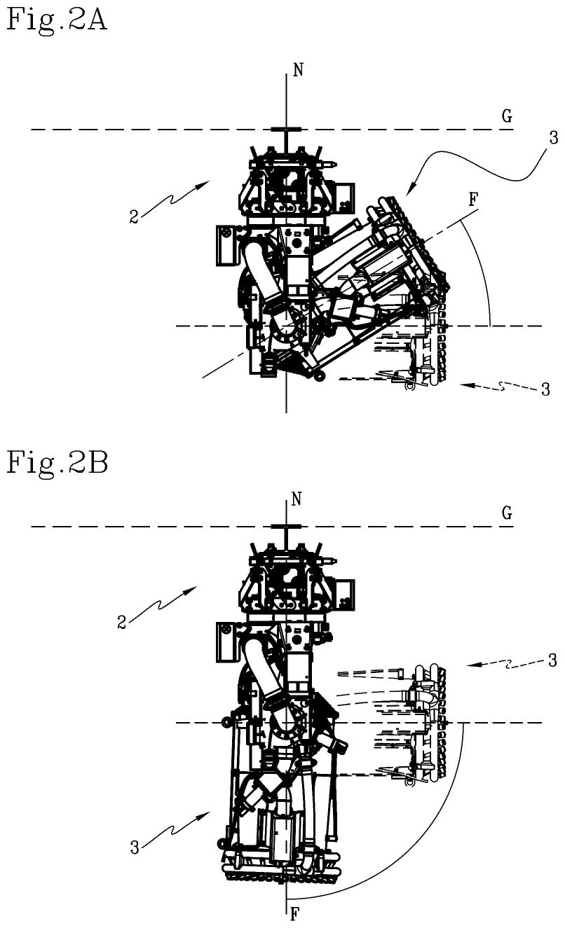

FIGS. 2A and 2B illustrate different further possible operating positions in which the fire-fighting cannon 1 illustrated in FIG. 1 is configurable.

Preferably, in fact, the movement means is configured to orient the tubular body 3 in any inclined position with respect to the normal direction N of any angle comprised between around +30°, (preferably +32°) and −90° (preferably −92°), in which the angle at 0° corresponds to the position in which the emission direction F is perpendicular to the normal direction N (FIG. 1).

In particular, considering as the initial position (i.e. the position at angle zero) the one in which the emission direction F is perpendicular to the normal direction N, the tubular body 3 can be oriented both upwards (or towards the lying plane G), i.e. towards the ceiling, and downwards, i.e. towards the ground.

In general, in the movement upwards (or towards the lying plane G), the tubular body 3 is able to abut in any one operating position for which the emission direction F is inclined by an angle comprised between 0° and +40° (preferably +32°). Consequently, in the movement downwards, the tubular body 3 is able to abut in any one operating position for which the emission direction F is inclined by an angle comprised between 0° and −110° (preferably −92°), including the position of inversion in which the angle of inclination is −90°.

As indicated above, the movement means is configured to orient said tubular body 3 in an inclined position that goes beyond said position of inversion with respect to said normal direction N, i.e. beyond −90° (preferably reaching up to −92°).

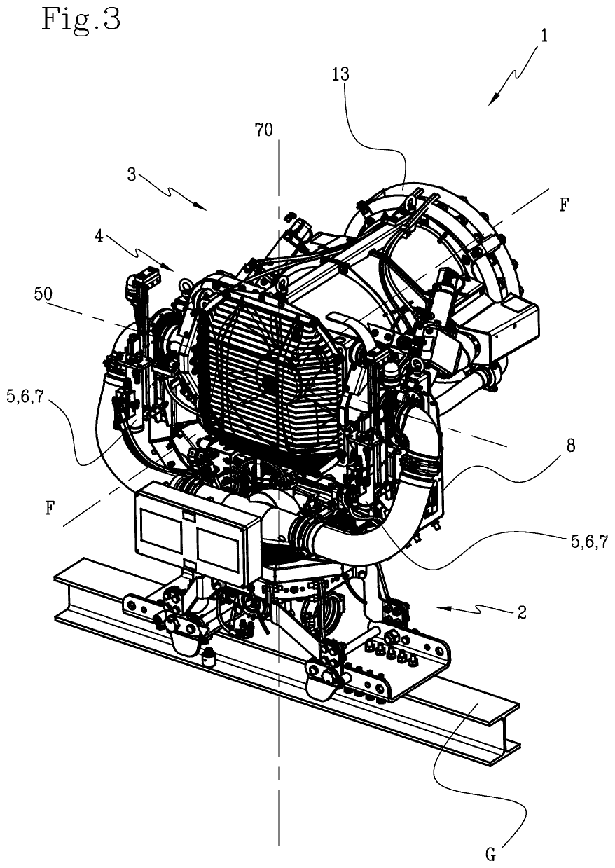

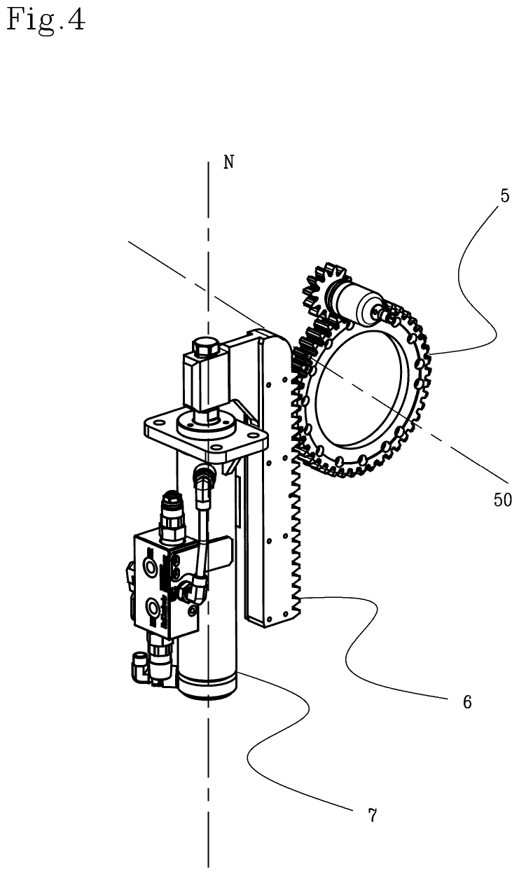

In accordance with an aspect of the invention illustrated in FIGS. 3 and 4, the movement means comprises a pinion 5 or toothed wheel connected to the tubular body 3, a rack 6 connected to the fixed base 2 and operatively engaged with the pinion 5, and first actuating members 7 configured to move the rack 6 along an operating direction L so as to rotate the pinion 5 which, in turn, moves the tubular body 3 between the plurality of possible operating positions.

Preferably, the first actuating members 7 comprise a hydraulic piston or pneumatic piston or electric piston.

Advantageously, therefore, the movement by the actuating members 7 determines a corresponding movement of the rack 6 along a direction parallel to the normal direction N to the lying plane G. Consequently, due to mechanical interference, the rack 6 places the pinion 5 in rotation, determining the corresponding rotation of the tubular body 3 between the possible operating positions.

Preferably, the rack 6 has a length such that, thanks to its movement, it is able to cause the pinion 5 to perform a number of rotations useful for orientation of the tubular body 3 into all the possible operating positions.

In other words, the rack 6 has a length adapted to the orientation of the emission direction F of the tubular body 3 in any one position inclined with respect to the normal direction N of any one angle comprised between +40° (preferably +32°) and −110° (preferably −92°).

In accordance with another aspect of the invention illustrated in FIGS. 3 and 4, the pinion 5 is arranged along a first rotation axis 50 of the tubular body 3 with respect to the fixed base 2 to orient the tubular body 3 itself in any one of the operating positions.

In this manner, therefore, the tubular body 3 is oriented in the different operating positions by means of a corresponding angular rotation with respect to the first rotation axis 50.

In accordance with a further aspect of the invention illustrated in FIG. 3, the fixed base 2 comprises a fork 8 for support of the tubular body 3. In particular, the fork 8 has, at its own end portions, coupling portions of the tubular body 3 that define a first rotation axis of the tubular body 3 itself.

Preferably, the pipes that carry water or fire-fighting liquid from the outside towards the tubular body are arranged at said end portions and in fluid communication towards the tubular body through rotating joints. There are preferably two of said rotating joints, since the pipes connected to them branch off into two branches from the outside towards the inside of the tubular body similarly to the shape of the fork 8.

It should also be noted that the fork 8 has a curved “U” shape, so that, substantially at the end portions, the coupling points are arranged between said fork 8 and the tubular body 3. Consequently, the coupling points also define a fulcrum around which the tubular body 3 is able to rotate. The first rotation axis 50 is therefore passing through said coupling points.

Preferably, the fork 8 is attached at an end portion 4 (rear with respect to the emission direction) of the tubular body 3, to allow orientation of the tubular body 3 itself in at least the position of inversion.

Advantageously, therefore, the tubular body 3 does not encounter any mechanical impediment by the fork 8 or, more generally, by the fixed base 2 during the orientation thereof between the different operating positions and, in particular, in the position of inversion. In the position of inversion, in fact, the end portion of the tubular body 3 is completely contained—with ease—inside the spatial dimensions of the fork 8, allowing alignment of the emission direction F with the normal direction N to the lying plane G.

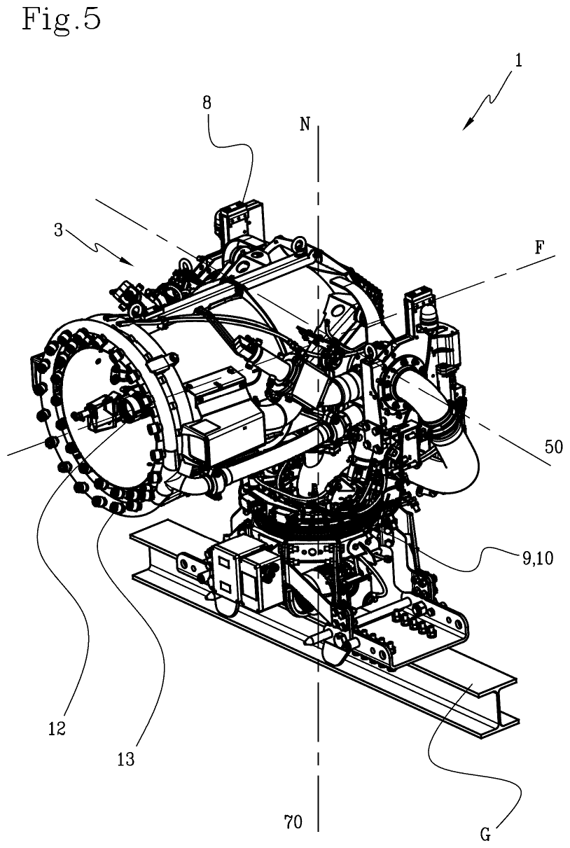

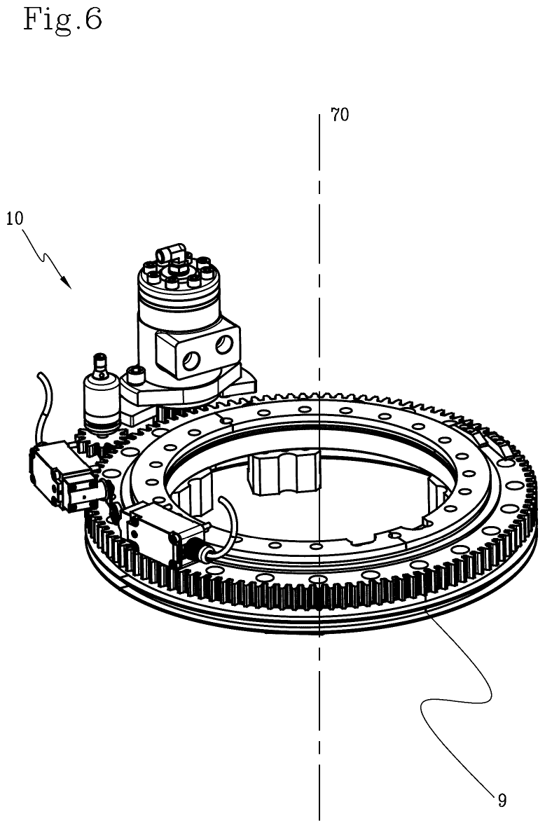

In accordance with an aspect of the invention illustrated in FIGS. 5 and 6, the cannon 1 comprises further movement means configured to move the tubular body 3 in rotation around a second rotation axis 70 parallel to the normal direction N.

Preferably, as more clearly visible in FIG. 6, the further movement means comprises a toothed crown 9 and second actuating members 10 associated with the toothed crown 9 to move the tubular body 3 around the second rotation axis.

Even more preferably, the second actuating means 10 comprises an electric motor configured to move the toothed crown 9 so as to rotate the tubular body 3 around the second rotation axis 70.

Advantageously, therefore, the combination between the movement due to the pinion 5 and to the toothed crown 9 allows the tubular body 3 to perform a substantially complete orbital movement. In other words, the emission direction F of the tubular body 3 is inclinable substantially by any solid angle with respect to the normal direction N to the lying plane G (i.e., to the vertical direction).

According to a preferred but not exclusive embodiment, the movement means and the further movement means are connected and fed by a hydraulic unit (or hydraulic pump). Such hydraulic unit is, in turn, moved by an electric motor fed by an inverter configured to vary the speed of the electric motor.

Advantageously, the application of an inverter allows the tubular body 3 to be rapidly oriented (i.e. inclined and/or rotated) into the desired operating position serving to extinguish a fire.

Even more advantageously, the inverter allows the movement of the tubular body 3 to be performed at the maximum speed possible and, subsequently, the movement to be slowed down to increase the precision of orientation, so as to obtain a perfect alignment between the zone in which the fire has broken out and the emission direction F. In fact, given that normally the distance between the fire-fighting cannon 1 and the fire is several, if not dozens, of meters, even a minimum error in angular positioning can cause a deviation of several metres between the fire zone and the zone into which the jet of fire-fighting fluid is directed, i.e. the emission direction F.

As an alternative to the embodiment described above, the movement means and the further movement means are directly moved by at least one electric motor fed by a corresponding inverter so as to control the movement thereof, i.e. the movement of inclination and/or rotation of the tubular body 3 to abut it in the operating positions. In other words, the use of a hydraulic unit for movement of the tubular body 3 is not envisaged.

In a further embodiment alternative with respect to the ones described, the movement means and the further movement means are directly moved by respective pneumatic actuators without the use of any inverter.

In other words, orientation of the emission direction F of the tubular body 3 between the different operating positions occurs by means of moving the latter in rotation around a first rotation axis 50 which, consequently, defines a circumference or at least a part thereof. The range of motion during orientation corresponds with a circumferential arc. The angle that subtends said circumferential arc corresponds with the angle of movement of the tubular body 3. With the same said angle, the breadth of the circumferential arc depends on the radius of said circumference which, in this specific case, corresponds with the distance between the fire-fighting cannon 1 and the zone in which the fire to be extinguished is present. Consequently, an error of even only one degree in positioning the tubular body 3 of the fire-fighting cannon 1 can cause a misalignment of several metres of the emission direction F with respect to the fire zone into which to direct the flow of fire-fighting fluid.

In accordance with an aspect of the invention, the fire-fighting cannon 1 comprises fire detecting means configured to detect the presence of any fires on the floor of the room.

The fire-fighting means can comprise various electric and/or electronic devices, such as infra-red detectors, thermal cameras or other types of sensors for the detection of smoke.

Advantageously, the fire-fighting means allows precise information on the presence of a fire to be obtained, for correct and rapid orientation, manually or preferably automatically, of the tubular body 3.

Preferably, the fire-fighting cannon 1 comprises an automatic pointing system configured to receive an alarm signal from the detecting means, containing information on the zone in which a fire has occurred. In addition, the automatic pointing system is configured to activate the cannon 1 and to generate a corresponding orientation signal to be sent to the movement means and further movement means so as to automatically orient the tubular body 3 towards the zone in which a fire has occurred.

In addition, said detecting means is configured to produce a regulation signal of the jet of fluid, preferably of the monitor 12 as a function of pointing, so as to facilitate regulation of the opening of the jet and/or the quantity of fluid towards said zone where the fire has occurred.

Therefore, the fire-fighting cannon 1 is advantageously able rapidly and precisely to alter the operating position of the tubular body 3 and, therefore, of the emission direction F of the flow of fire-fighting fluid.

Even more advantageously, the fire-fighting cannon 1 is able to act promptly, spraying fire-fighting fluid firstly over the zone in which the fire is effectively present, in contrast with what is done by the cannons in the prior art, which start by defining an outer perimeter of the fire, generally oversized, and then move with a repetitive movement, for example a zig-zag one, to cover the surface inside said outer perimeter.

In accordance with an aspect of the invention, the tubular body 3 comprises an emission monitor 12 configured to emit a first part of the jet of fire-fighting fluid substantially along the emission direction F. In particular, the emission monitor 12 is arranged substantially at the centre of the tubular body 3, along the emission direction F.

Advantageously, the emission monitor 12 is substantially a delivery hose configured to emit a main flow of fire-fighting fluid with at a flow rate and with an adjustable output, in order to be able to reach an output of even dozens of metres.

Preferably, the emission monitor 12 comprises a pressure sensor arranged at an emission mouth 20 of said monitor 12, which is configured to detect changes in output pressure of the fire-fighting fluid. In particular, the pressure sensor is configured to detect any malfunctions, with respect to the reference pressure value, and to produce an alarm signal.

In this manner, the pressure sensor advantageously allows any malfunctions of the monitor 12, for example non-emission of the fire-fighting fluid, to be assessed precisely. In fact, the arrangement directly at the emission mouth 20 allows the effective change—or cancellation—of pressure that can occur on exiting from the monitor 12 to be assessed.

Furthermore, the monitor 12 is configured to vary its own emission configuration, preferably the opening and closing of the jet of fluid, as a function of the pressure detected by the pressure sensor, so as to set a correct emission parabola of the jet of fluid with respect to a theoretical parabola calculated solely on the basis of the inflowing fluid pressure.

For example, if the pressure of the inflowing fluid is 11 bar and it is necessary to spray a certain zone at a certain distance, the monitor 12 is adjusted in order to adequately cover said zone with a certain emission parabola. However, if due to internal problems the final pressure is not at 11 bar, but 9 bar, the pre-set adjustment of the monitor 12 does not produce a correct parabola to satisfy the needs. Advantageously, on the other hand, knowing the effective pressure value exiting from the monitor 12 makes it possible to adjust the configuration of the monitor 12 to obtain a correct parabola.

The fire-fighting cannons of the prior art, in fact, provide for operating sensors along the delivery conduits of the flow of fire-fighting fluid upstream of the monitor. Therefore, these sensors might not detect any change in pressure caused by possible pressure drops downstream of their position that could cause a drop in pressure or emission flow rate from the monitor 12.

In accordance with another aspect of the invention, the emission monitor 12 comprises a flow regulation device configured to regulate the flow rate of emission of the fire-fighting fluid by means of said emission monitor 12.

In this manner, the regulation device is advantageously able to change the emission output of the first part of the flow of fire-fighting fluid emitted by the monitor 12. Preferably, the regulation device is configured to change (increase or decrease) the opening section of the emission mouth 20 of the monitor 12.

In accordance with a preferred aspect of the invention, the fire-fighting cannon 1 comprises a control unit configured to automatically regulate opening of the emission mouth 20 of the monitor 12, so as to regulate the output of the flow of fire-fighting fluid as a function of the distance from the zone in which the fire is present.

In detail, the control unit is configured to receive a localisation signal representative of the distance between the fire-fighting cannon 1 and the zone of interest where the fire is present. As a function of said localisation signal, the control unit is configured to send an orientation signal to the movement means and to the further movement means to perform orientation of the tubular body 3 and, furthermore, a regulation signal to the regulation device for regulating opening of the emission mouth 20 of the monitor 12 and, therefore, its emission output.

In accordance with another aspect of the invention, the tubular body 3 comprises a plurality of atomising nozzles 13, preferably arranged in a crown, operatively associated with an emission mouth 20 of the tubular body 3 to spray at least a second part of the jet of fire-fighting fluid along the emission direction F.

The plurality of atomising nozzles allows a cloud of fire-fighting fluid, i.e. the second part of the jet of fire-fighting fluid, to be obtained, with a lower output with respect to the monitor 12, but capable of facilitating extinguishing of the fire.

In accordance with a further aspect of the invention, the fire-fighting cannon 1 comprises blowing means 21 (turbine) operatively associated with the tubular body 3 to produce a flow of air along the emission direction F from an inlet opening 22 towards an outlet opening of said tubular body.

Advantageously, the flow of air allows easier conveying of the second part of the jet of fire-fighting fluid emitted by the plurality of nozzles towards the zone of interest where the fire to be extinguished is present.

A further object of the present invention is a method for managing fires that derives directly from what is described above in relation to the cannon, which is entirely referenced here below.

In particular, the method comprises the following operating steps:
arranging a fire-fighting cannon having a fixed base 2, defining a corresponding lying plane G, and a tubular body 3 extending along an emission direction F of at least one jet of fire-fighting fluid and, furthermore, connected to said fixed base 2;
moving said tubular body 3 with respect to said fixed base 2 so as to orient it between a plurality of angular operating positions, including an initial position in which said emission direction F has a predefined angle of inclination with respect to a normal direction N with respect to the lying plane G.

In accordance with the present invention, the method comprises the following further steps:
constraining said fixed base 2 to a ceiling or to a vertical wall of a room so that said tubular body 3 is arranged below (upside down) or alongside said fixed base 2 with respect to said normal direction N;
orienting (by means of said movement means) said tubular body 3 also in a position of inversion in which said emission direction F is parallel to said normal direction N, so as to emit said at least one jet of fire-fighting fluid in a zone of ground arranged underneath the fire-fighting cannon 1 if the fixed base 2 is constrained to the ceiling, or in a zone with horizontal output if the fixed base 2 is constrained to the wall.

The present invention allows the intended objects to be achieved.

In particular, thanks to the movement system, the cannon according to the present invention allows a larger emission area to be covered and in a more flexible manner with respect to the prior art.

Furthermore, the cannon is directly fixable to the ceiling or to a wall without this limiting the fire extinguishing capacity.

1. A fire-fighting cannon for management of fires, the fire-fighting cannon comprising:
a fixed base constrainable to a ceiling or to a vertical wall of a room, so as to define a corresponding lying plane;
a tubular body extending along an emission direction of at least one jet of fire-fighting fluid and connected to the fixed base;
the tubular body comprising a plurality of atomising nozzles operatively associated with an emission mouth of the tubular body to spray at least a part of the jet of fire-fighting fluid along the emission direction;
blowing means including a turbine, operatively associated with the tubular body to produce a flow of air along the emission direction from an inlet opening towards the emission mouth of said tubular body;
the tubular body being arranged below or alongside the fixed base with respect to a normal direction to the lying plane;
movement means for moving the tubular body with respect to the fixed base and configured to orient the tubular body between a plurality of operating positions, including an initial position in which the emission direction has a predefined angle of inclination with respect to the normal direction;
wherein the movement means is also configured to orient the tubular body in a position of inversion in which the emission direction is parallel to the normal direction, so as to emit the at least one jet of fire-fighting fluid in a zone of a ground arranged underneath the fire-fighting cannon if the fixed base is constrained to the ceiling, or in a zone with horizontal output if the fixed base is constrained to the wall.

2. The fire-fighting cannon according to claim 1, wherein the movement means is configured to orient the tubular body in an inclined position that goes beyond the position of inversion with respect to the normal direction.

3. The fire-fighting cannon according to claim 1, wherein the movement means is configured to orient the tubular body in any inclined position with respect to the normal direction of any angle between around +40° and −110° in which the angle at 0° corresponds to the position in which the emission direction is perpendicular to the normal direction.

4. The fire-fighting cannon according to claim 1, wherein the movement means comprises:
a pinion or toothed wheel connected to the tubular body;
a rack connected to the fixed base and operatively meshed with the pinion;
first actuating members configured to move the rack along an operating direction so as to rotate the pinion, which in turn moves the tubular body between the plurality of operating positions.

5. The fire-fighting cannon according to claim 4, wherein the first actuating members comprise a hydraulic piston, a pneumatic piston or an electric piston.

6. The fire-fighting cannon according to claim 4,
wherein the pinion is arranged along a first rotation axis of the tubular body with respect to the fixed base to orient the tubular body in any one of the operating positions;
wherein the rack includes an extension in length such as to be able to reach any one of the operating positions, including the position of inversion.

7. The fire-fighting cannon according to claim 1, wherein the fixed base comprises a fork for support of the tubular body, the fork having coupling points of the tubular body defining a first rotation axis of the tubular body.

8. The fire-fighting cannon according to claim 7, wherein the fork is coupled at an end portion of the tubular body to allow orientation of the tubular body in at least the position of inversion.

9. The fire-fighting cannon according to claim 1, further comprising further movement means configured to move the tubular body in rotation around a second rotation axis parallel to the normal direction.

10. The fire-fighting cannon according to claim 9, wherein the further movement means comprises a toothed crown and second actuating members associated with the toothed crown to move the tubular body around the second rotation axis.

11. The fire-fighting cannon according to claim 9,
wherein the movement means and the further movement means are connected to and fed by a hydraulic unit, the hydraulic unit being in turn moved by an electric motor fed by an inverter configured to vary a speed of the electric motor.

12. The fire-fighting cannon according to claim 9, wherein the movement means and the further movement means are directly moved by at least one electric motor fed, in turn, by a corresponding inverter, so as to control the inclination and/or rotation of the tubular body.

13. The fire-fighting cannon according to claim 1, wherein the tubular body comprises an emission monitor configured to emit a first part of the jet of fire-fighting fluid substantially along the emission direction, the emission monitor being arranged substantially at a center of the tubular body along the emission direction.

14. The fire-fighting cannon according to claim 13, wherein the emission monitor further comprises a pressure sensor arranged at the emission monitor and configured to detect variations in an output pressure of the fire-fighting fluid at the emission monitor, the pressure sensor being configured to detect malfunctions, with respect to a reference pressure value and to produce an alarm signal.

15. The fire-fighting cannon according to claim 14, wherein the emission monitor is configured to vary an emission configuration, including an opening and closing of the jet of fluid, as a function of the pressure detected by the pressure sensor, so as to set a correct emission parabola of the jet of fluid with respect to a theoretical parabola calculated solely on a basis of an inflowing fluid pressure.

16. The fire-fighting cannon according to claim 13, wherein the emission monitor comprises a flow regulation device configured to regulate a flow rate of emission of the fire-fighting fluid by means of the emission monitor.

17. A fire management method, the method comprising steps of:
arranging a fire-fighting cannon having a fixed base, defining a corresponding lying plane, and a tubular body extending along an emission direction of at least one jet of fire-fighting fluid and connected to the fixed base;
the step of arranging the fire-fighting cannon provides for obtaining a tubular body comprising a plurality of atomising nozzles, arranged in a crown, operatively associated with an emission mouth of the tubular body to spray at least a part of the jet of fire-fighting fluid along the emission direction, the fire-fighting cannon further comprising blowing means, including a turbine, operatively associated with the tubular body to produce a flow of air along the emission direction from an inlet opening towards the emission mouth of the tubular body;
moving the tubular body with respect to the fixed base so as to orient the tubular body between a plurality of operating positions, including an initial position in which the emission direction has a predefined angle of inclination with respect to a normal direction with respect to the lying plane;
constraining the fixed base to a ceiling or to a vertical wall of a room so that the tubular body is arranged below or alongside the fixed base with respect to the normal direction;
orienting the tubular body also in a position of inversion in which the emission direction is parallel to the normal direction, so as to emit the at least one jet of fire-fighting fluid in a zone of ground arranged underneath the fire-fighting cannon if the fixed base is constrained to the ceiling, or in a zone with horizontal output if the fixed base is constrained to the wall.

18. The fire-fighting cannon of claim 1, wherein the room is a room of a waste disposal centre.

19. The fire-fighting cannon of claim 1, wherein the movement means is configured to orient the tubular body in any inclined position with respect to the normal direction of any angle between around +30° and −90° in which the angle at 0° corresponds to the position in which the emission direction is perpendicular to the normal direction.

20. The fire-fighting cannon of claim 1, wherein the plurality of atomising nozzles are arranged in a crown.
